(19) United States
(12) Patent Application Publication
(10) Pub. No.: US 2005/0013270 A1
(43) Pub. Date: Jan. 20, 2005

(54) Method and system for de-registering a broadcast/multicast service in a high-rate packet data system

(76) Inventors: Yong Chang, Seongnam-si (KR); Nae-Hyun Lim, Seoul (KR); Jun-Hyuk Song, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/890,295

(22) Filed: Jul. 14, 2004

(30) Foreign Application Priority Data
Jul. 14, 2003 (KR) 2003-47940
Aug. 18, 2003 (KR) 2003-57035

(51) Int. Cl. H04Q 7/00

(52) U.S. Cl. 370/328

(57) ABSTRACT

A system and method for de-registering a Broadcast/Multicast Service (BCMCS) in a high-rate packet data system including an access network (AN) for performing radio communication with an access terminal (AT), a packet control function (PCF) for processing packet data communication, and a packet data service node (PDSN) connected to a BCMCS contents server (CS) via a packet communication network is provided. In the system and method, the access network receives a de-registration message for a release request of a BCMCS service from the access terminal. The access network transmits a BCMCS release message including BCMCS information with a release request, to the packet control function. The packet control function transmits a BCMCS registration request message including the BCMCS information to the packet data service node. The packet data service node performs a release and accounting process on a corresponding BCMCS service based on the BCMCS information.

### PRIORITY

This application claims the benefit under 35 U.S.C. § 119(a) of two applications filed in the Korean Intellectual Property Office on Jul. 14, 2003 and Aug. 18, 2003 and assigned Serial Nos. 2003-47940 and 2003-57035, respectively, the entire contents of both of which are incorporated herein by reference.

### BACKGROUND OF THE INVENTION

1. Field of the Invention

The present invention relates generally to a method and system for providing a Broadcast/Multicast Service (BCMCS) service through a high-rate packet data system. In particular, the present invention relates to a method and system for de-registering (or releasing) a BCMCS service in response to a BCMCS release request from a user or a broadcasting system.

2. Description of the Related Art

Communication systems are undergoing change without regards to the type of coverage such as wire/wireless area, region or country. In particular, communication systems such as International Mobile Telecommunication-2000 (IMT-2000) tend to collectively provide various information desired by a user as well as video and sound information on a real-time basis. With the development of mobile communication technology, existing mobile communication systems enabling users to perform voice communication using an access terminal (AT) such as a cellular phone or a personal communications system (PCS) phone have evolved into an advanced mobile communication system capable of enabling users not only to transmit text information but also to view a BCMCS service using an access terminal. In 3^{rd} Generation Partnership Project 2 (3GPP2) providing a broadcast service using Code Division Multiple Access (CDMA) technology, various standards are being developed. A broadcast service proposed in the 3GPP2 is called “Broadcast/Multicast Service (BCMCS).”

A common packet data service provided in a mobile communication system is supported by Unicast. In Unicast, a network address of a particular user is designated for data transmission and reception, and an access network (AN) assigns radio resources for data transmission to a corresponding user, thereby providing a packet data service. However, in BCMCS supporting Broadcast, because the same service is simultaneously provided to a plurality of unspecified users, a service provider cannot recognize service recipients.

Describing wireless BCMCS technology, an access terminal tunes to a BCMCS frequency selected when the access terminal first accesses an access network, and initiates a BCMCS service. During the BCMCS service, the access terminal registers its location in the system periodically or aperiodically. Commonly, location registration for an access terminal in BCMCS service is performed in synchronism with a new service frequency, or when the access terminal moves a particular distance.

In BCMCS, location registration information is provided to a contents server that provides a BCMCS service to an access terminal, and the contents server can use the location registration information in indicating a BCMCS service the access terminal is receiving or a BCMCS service the access terminal desires to receive. Information generated in the location registration procedure for an access terminal can be used as information for billing. Conventionally, a de-registration procedure for closing (or releasing) a BCMCS service of an access terminal was not defined.

However, if a scheme for releasing a BCMCS service is not separately defined, a user cannot release the BCMCS service at the desired time. In this case, a service release request by a user cannot be processed on a real-time basis, so that the user may be overcharged. Furthermore, in a mobile communication system, although the user has suspended use of a BCMCS service, the user is continuously assigned radio resource, thereby resulting in a waste of wire/wireless resource used for BCMCS.

### SUMMARY OF THE INVENTION

It is, therefore, an object of the present invention to provide a method and system for de-registering a BCMCS service upon receiving a BCMCS release request from an access terminal or a packet data service node.

It is another object of the present invention to provide a method and system for performing a release and accounting process on a BCMCS service upon receiving a BCMCS release request from an access terminal or a packet data service node.

In accordance with one aspect of the present invention, there is provided a Broadcast/Multicast Service (BCMCS) de-registration method performed in an access network in a high-rate packet data system including the access network (AN) for performing radio communication with an access terminal (AT), a packet control function (PCF) for processing packet data communication, and a packet data service node (PDSN) connected to a BCMCS contents server (CS) via a packet communication network. The method comprises the steps of receiving a de-registration message for a release request of a BCMCS service from the access terminal; transmitting a BCMCS release message including BCMCS information for a release process by the packet data service node, to the packet control function; and receiving a BCMCS release complete message from the packet control function in response to the BCMCS release message. The packet data service node transmits a BCMCS registration reply message to the packet control function in response to the BCMCS registration request message. The packet control function transmits a BCMCS release complete message indicating completion of a release process on the corresponding BCMCS service to the access network.

In accordance with one aspect of the present invention, there is provided a Broadcast/Multicast Service (BCMCS) de-registration method performed in a packet control function in a high-rate packet data system including an access network (AN) for performing radio communication with an access terminal (AT), the packet control function (PCF) for processing packet data communication, and a packet data service node (PDSN) connected to a BCMCS contents server (CS) via a packet communication network. The method comprises the steps of receiving a BCMCS release message for a release request of a BCMCS service from the access network; transmitting a BCMCS registration request message including BCMCS information for a release process to the packet data service node; and receiving a BCMCS registration reply message from the packet data service node according to a result of the release process, and sending a BCMCS release complete message to the access network.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a high-rate packet data system supporting Broadcast/Multicast Service (BCMCS) according to an embodiment of the present invention;

FIG. 2 is a message flow diagram illustrating a BCMCS de-registration method according to an embodiment of the present invention;

FIGS. 3A through 3E are diagrams illustrating a format of an A9-BCMCS Release-A8 message transmitted from an access network to a packet control function according to an embodiment of the present invention;

FIGS. 4A through 4C are diagrams illustrating a format of an A9-BCMCS Release Complete-A8 message transmitted from a packet control function to an access network according to an embodiment of the present invention;

FIGS. 5A through 5E are diagrams illustrating a format of an A11-BCMCS Registration Request message transmitted from a packet control function to a packet data service node according to an embodiment of the present invention;

FIGS. 6A and 6B are diagrams illustrating a Normal Vendor/Organization Specific Extension (NVSE) field included in the A11-BCMCS Registration Request message;

FIGS. 7A through 7E are diagrams illustrating a format of an A11-BCMCS Registration Reply message transmitted from a packet data service node to a packet control function according to an embodiment of the present invention;

FIG. 8 is a message flow diagram illustrating a BCMCS de-registration method according to another embodiment of the present invention;

FIGS. 9A through 9D are diagrams illustrating a format of an A11-BCMCS Registration Update message transmitted from a packet data service node to a packet control function according to another embodiment of the present invention; and

FIGS. 10A through 10C are diagrams illustrating a format of an A9-BCMCS Disconnect-A8 message transmitted from a packet control function to a access network according to another embodiment of the present invention.

In the drawings, it should be noted that the same or similar elements are denoted by like reference numerals throughout the drawings.

### DETAILED DESCRIPTION OF THE EXEMPLARY EMBODIMENTS

Several embodiments of the present invention will now be described in detail with reference to the accompanying drawings. In the following description, a detailed description of known functions and configurations incorporated herein has been omitted for conciseness.

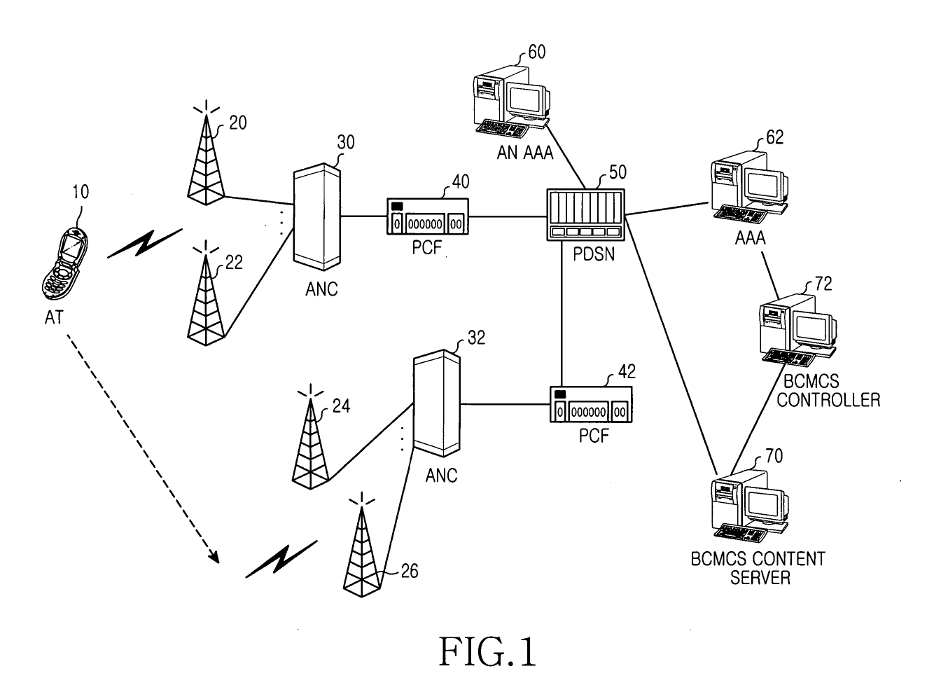

FIG. 1 is a diagram illustrating a configuration of a high-rate packet data system supporting Broadcast/Multicast Service (BCMCS) according to an embodiment of the present invention. As illustrated in FIG. 1, the high-rate packet data system includes access network transceiver subsystems (ANTSs) 20, 22, 24 and 26 for performing wireless communication with an access terminal (AT) 10, access network controllers (ANCs) 30 and 32 for controlling the ANTSs 20, 22, 24 and 26, and packet control functions (PCFs) 40 and 42, connected between a packet data service node (PDSN) 50 and the access network controllers 30 and 32, for processing packet data communication.

In addition, the system includes the packet data service node 50 for providing a data service to the access terminal 10, an Authentication, Authorization and Accounting (AAA) server 62 for managing accounting and service authentication for a BCMCS user in cooperation with the packet data service node 50, an access network (AN) AAA server 60 for managing AT authentication in the high-rate packet data system, a contents server (CS) 70 for providing broadcasting contents to the packet data service node 50, and a BCMCS controller 72 for controlling an overall BCMCS operation.

As is known, access network transceiver subsystems 20, 22, 24 and 26 and the access network controllers 30 and 32 comprise an access network (AN). When a BCMCS service is achieved based on packet communication, the packet data service node 50 is connected to other network elements, such as the AAA server 62, the BCMCS controller 72, and the contents server 70, via a packet data network such as the Internet. The AAA server 62 communicates with a subscriber information database (not shown) in order to manage broadcast authentication and accounting.

The BCMCS controller 72 provides BCMCS session information, such as IP Multicast address, Port number, Encryption key and BCMCS ID, to the packet data service node 50 and the access terminal 10. The BCMCS contents server 70, a BCMCS provider, manages encryption of broadcasting contents when encryption by an application layer is used. The BCMCS contents server 70 is provided with broadcasting contents from a BCMCS contents provider (not shown).

In an embodiment of the present invention for a BCMCS de-registration procedure in the high-rate packet data system a function of transferring a BCMCS release message and accounting information (or billing information) is provided. Specifically, an embodiment of the present invention provides a scheme for transferring a release message in order to suspend transmission and reception of broadcasting contents to and from a user or a communication node of a broadcasting system such as the packet data service node in the high-rate packet data system. In addition, the embodiment of the present invention includes a function of processing accounting information through a BCMCS release procedure.

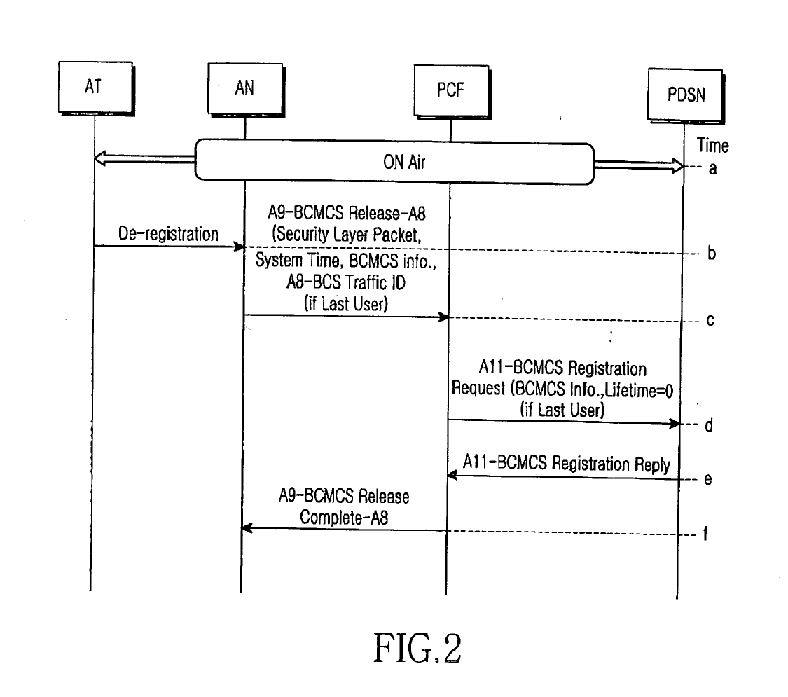

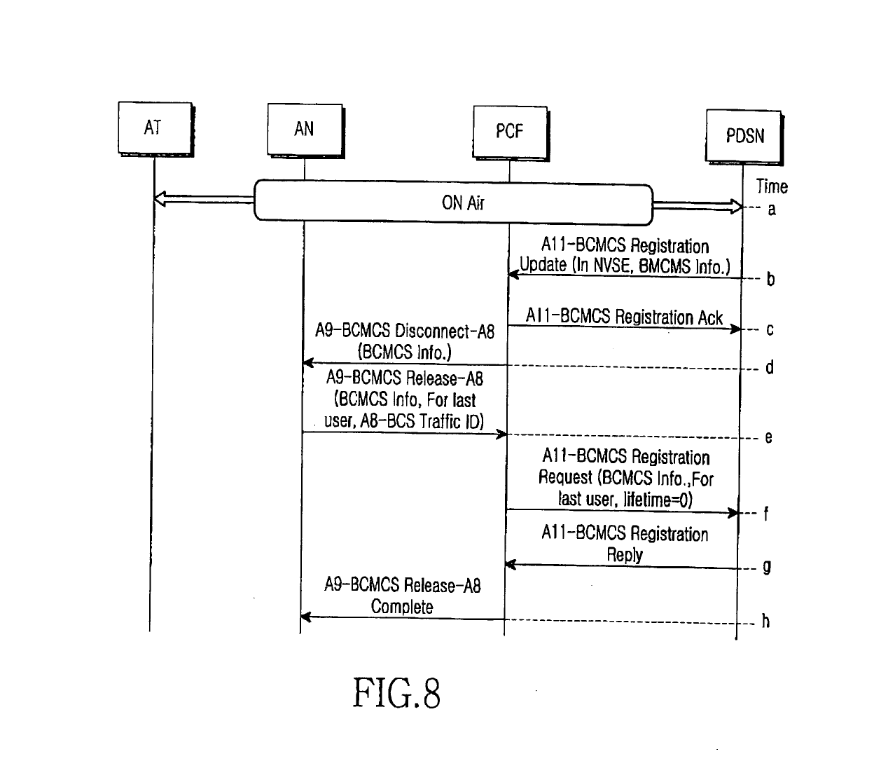

With reference to FIGS. 2 through 7E, a description will be first made of a BCMCS de-registration procedure according to an embodiment of the present invention in a case where a BCMCS release request is received from an access terminal. Next, with reference to FIGS. 8 through 10C, a description will be made of a BCMCS de-registration procedure according to an embodiment of the present invention in a case where a BCMCS release request is received from a packet data service node.

FIG. 2 is a message flow diagram illustrating a BCMCS de-registration method according to an embodiment of the present invention. Among the elements comprising the high-rate packet data system, only the elements related to the embodiment of the present invention are illustrated herein for conciseness.

Referring to FIG. 2, in step ‘a’, an access terminal (AT) receives BCMCS service from a packet data service node (PDSN) via an access network (AN) and a packet control function (PCF), and it is assumed herein that the packet data service node receives data including broadcasting contents from a contents server that is not shown. In step ‘b’, the access terminal sends a De-registration message including BCMCS ID information of a current BCMCS service to the access network in order to request suspension of the current BCMCS service.

In step ‘c’, the access network receiving the De-registration message sends an A9-BCMCS Release-A8 message to the packet control function. The A9-BCMCS Release-A8 message includes a Security Layer Packet and System Time, BCMCS Info and A8 BCS Traffic ID for a BCMCS service the access terminal is receiving. The BCMCS Info including Time Stamp of the BCMCS service can be used for an accounting process.

While a connection between the access network and the packet control function is separately made for each user in Unicast, a connection between the access network and the packet control function is commonly made for all users in BCMCS. Therefore, although one of a plurality of access terminals in BCMCS service transmits a De-registration message, the connection between the access network and the packet control function is not required to be released. However, when the last user transmits a De-registration message, the connection for the corresponding BCMCS service between the access network and the packet control function is not required to be maintained, so the access network transmits the A8 BCS Traffic ID indicating the corresponding connection to the packet control function, thereby requesting release of the connection.

In step ‘d’, the packet control function includes the BCMCS Info received from the access network in an A11-BCMCS Registration Request message, and sends the A11-BCMCS Registration Request message to the packet data service node. The BCMCS Info is recognized as accounting information for a BCMCS service. If the access terminal is the last user using a corresponding BCMCS connection, such as if no more users are using the corresponding BCMCS connection, a Lifetime field in the A11-BCMCS Registration Request message is set to ‘0’.

In step ‘e’, the packet data service node processes BCMCS accounting for the access terminal according to the BCMCS Info, and in response, sends an A11-BCMCS Registration Reply message to the packet control function. In step ‘f’, the packet control function sends an A9-BCMCS Release Complete-A8 message to the access network, thereby indicating completion of the BCMCS de-registration procedure. Then the access network receiving the A9-BCMCS Release Complete-A8 message determines presence/absence of a user, and disconnects the connection to the packet control function in the absence of a user.

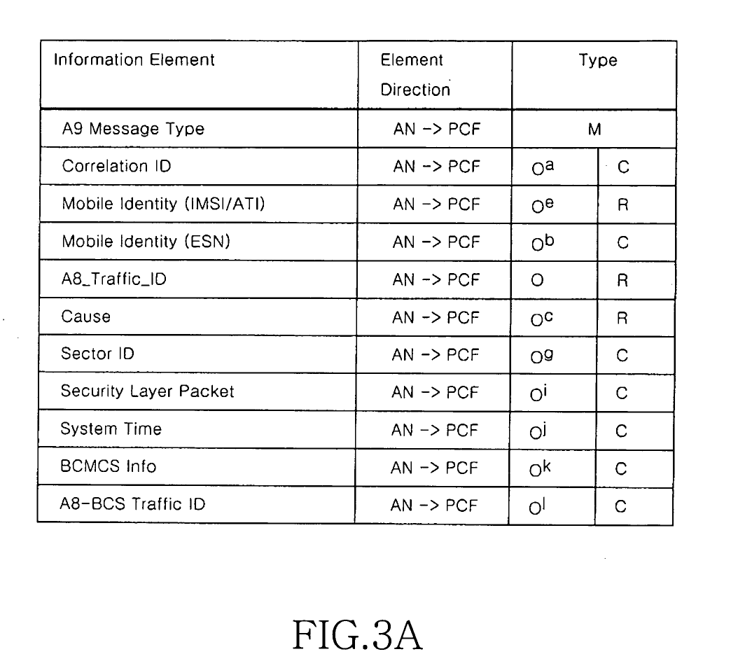

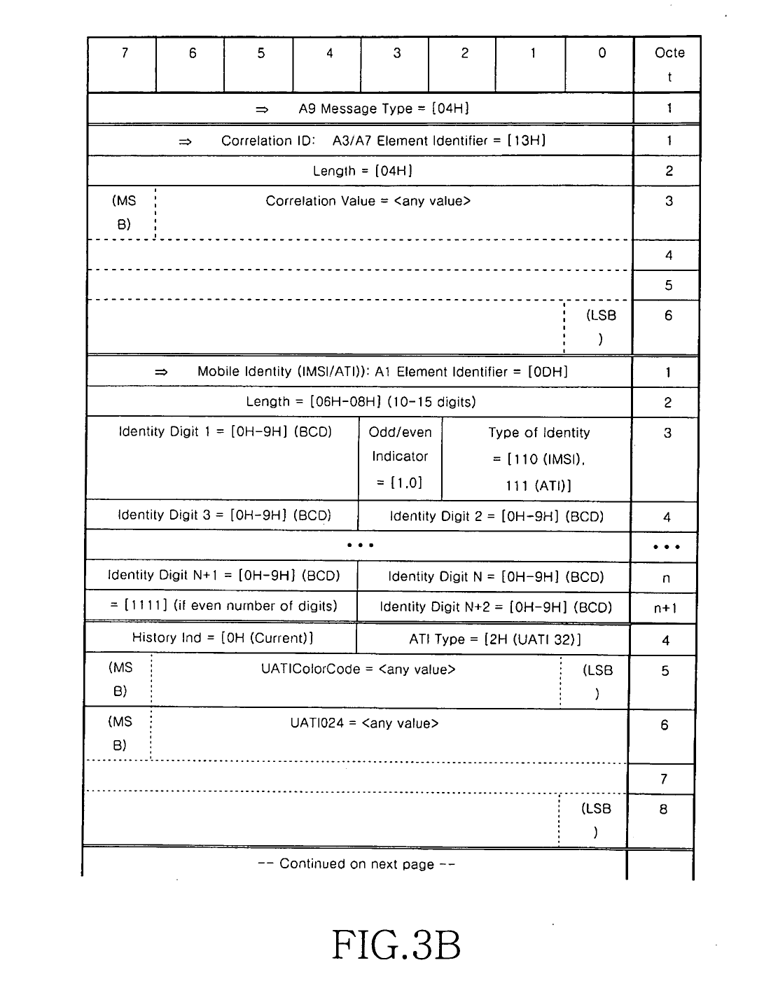

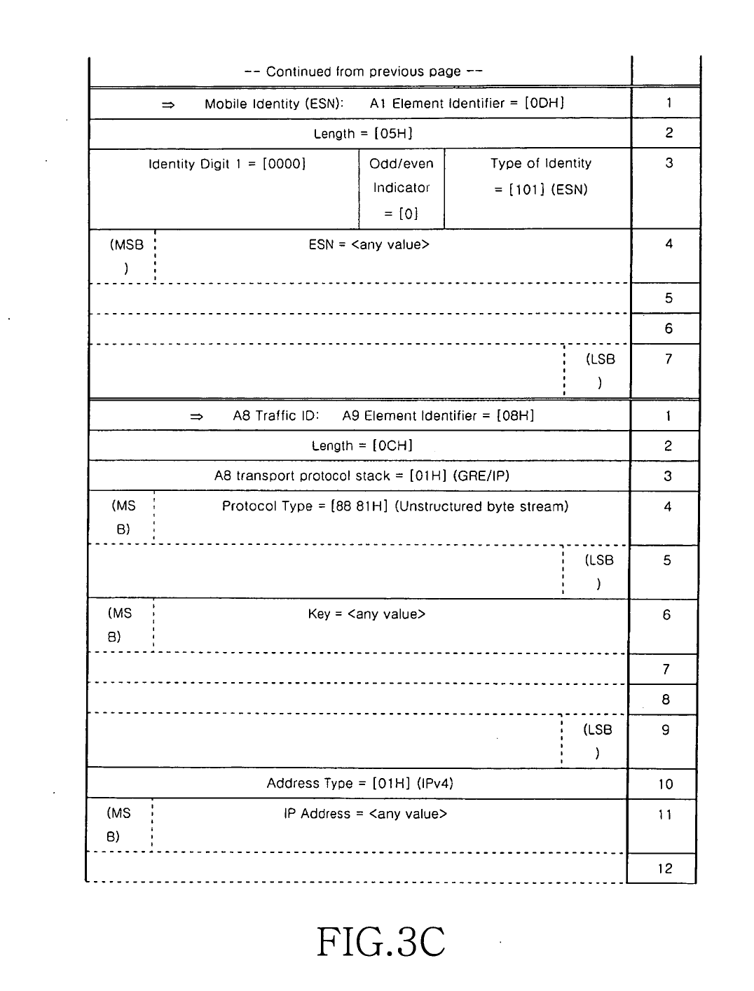

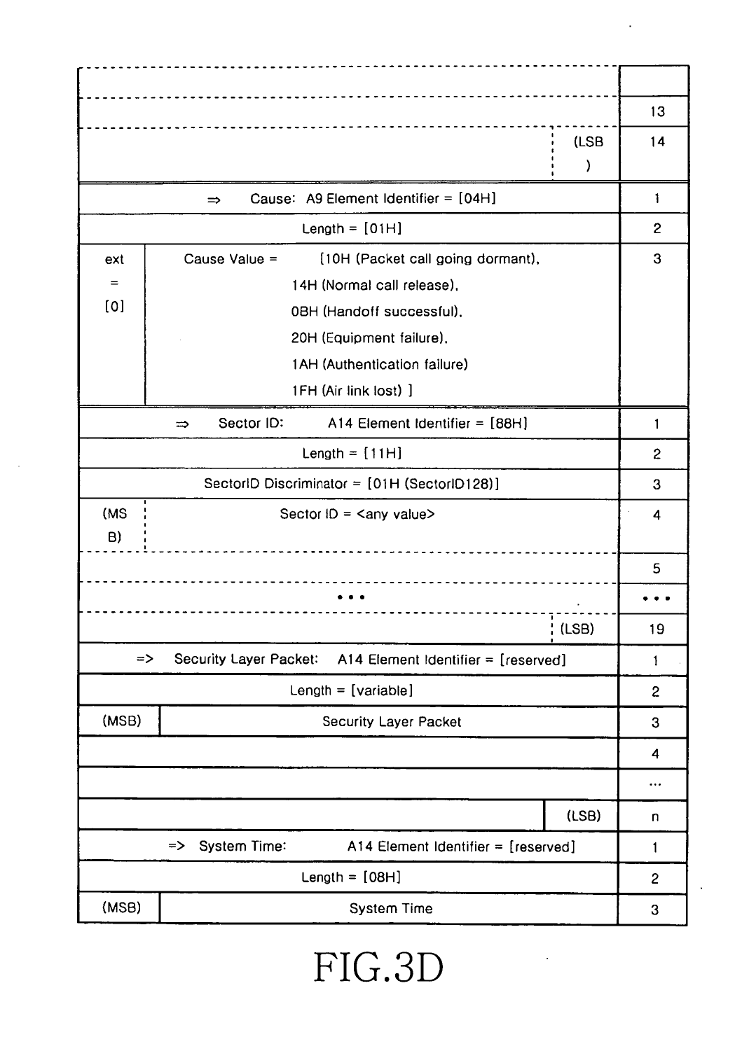

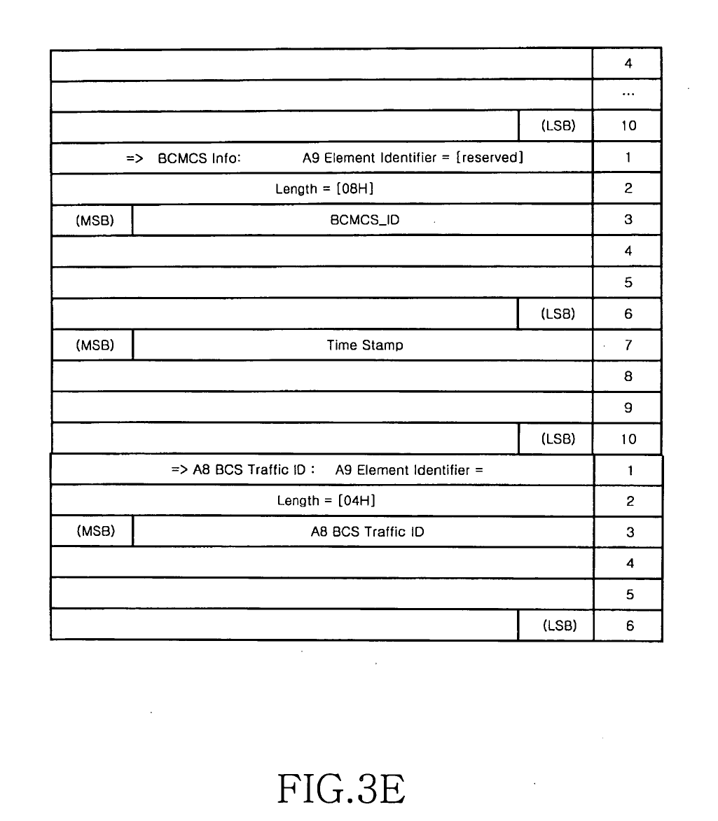

FIGS. 3A through 7E are diagrams illustrating formats of messages transmitted in the BCMCS de-registration method according to an embodiment of the present invention. Among information elements comprising the messages in FIGS. 3A through 7E, only the parameters used for BCMCS de-registration will be described in detail, for conciseness.

FIG. 3A is a diagram illustrating a simplified format of the A9-BCMCS Release-A8 message transmitted from the access network to the packet control function according to an embodiment of the present invention. FIGS. 3B through 3E are diagrams illustrating a detailed format of the A9-BCMCS Release-A8 message.

As illustrated in FIG. 3A, the A9-BCMCS Release-A8 message includes a Message Type field, a Correlation ID field, Mobile Identity fields, an A8-Traffic_ID field for the use of unicast, a Cause field, a Sector ID field, a Security Layer Packet field, a System Time field, a BCMCS Info field, and a BCS Traffic ID.

The Security Layer Packet field is compared with Security Layer Packet stored in the packet control function. That is, the packet control function performs service connect and release only when a packet transmitted by the access terminal is identical to a packet previously stored in the packet control function. The security packet is used for security communication with the access terminal, and is distinguished from a data packet including broadcasting contents. System Time refers to a duration of the Security Layer Packet.

As illustrated in FIG. 3E, BCMCS Info includes BCMCS_ID and Time Stamp. The BCMCS_ID refers to broadcasting contents the access terminal desires to release, and is received from the access terminal through the De-registration message. The Time Stamp refers to a time when the De-registration message from the access terminal is received at the access network, that is, an access network controller. The Time Stamp is used for accounting.

If control on a BCMCS service is transferred from a source packet control function (source PCF) to a target packet control function (target PCF) because handoff occurs during a packet control period where the access terminal receives the BCMCS service, a timer value in the source packet control function is transferred to the target packet control function, so that the target packet control function continuously performs accounting using the provided timer value. Therefore, in case of a handoff, the A9-BCMCS Release-A8 message is not transmitted.

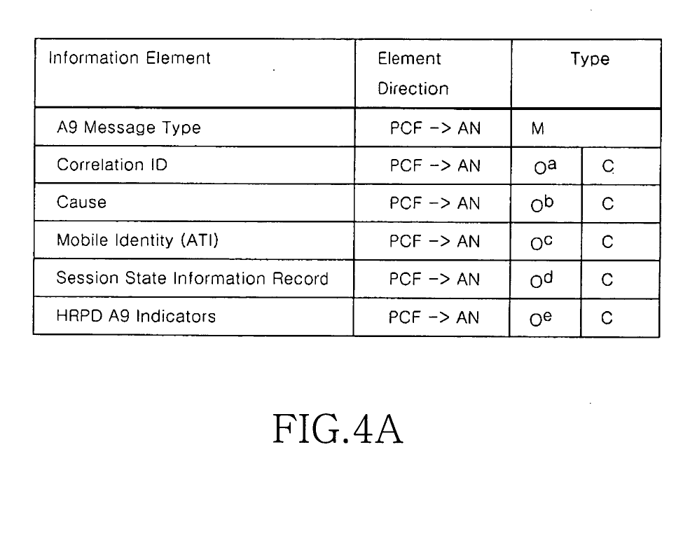

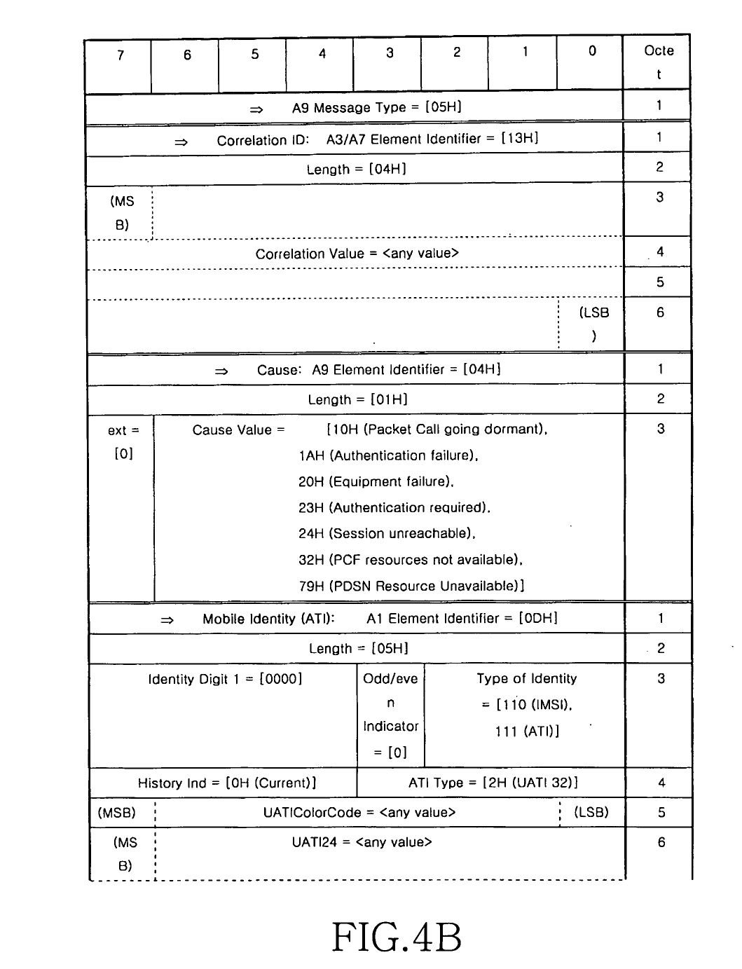

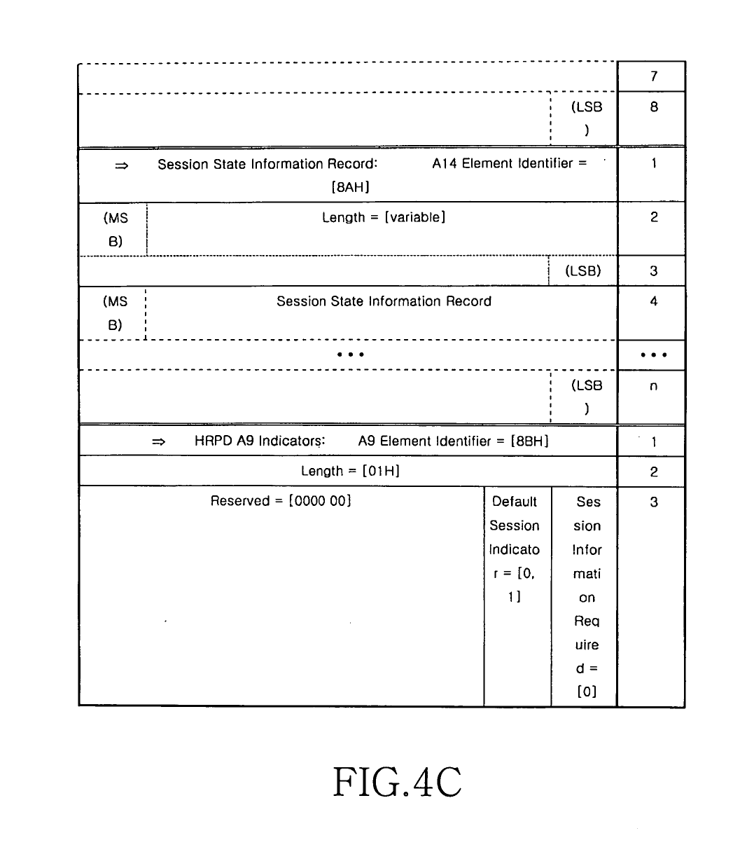

FIG. 4A is a diagram illustrating a simplified format of the A9-BCMCS Release Complete-A8 message transmitted from the packet control function to the access network according to an embodiment of the present invention. FIGS. 4B and 4C are diagrams illustrating a detailed format of the A9-BCMCS Release Complete-A8 message. As illustrated in FIG. 4A, the A9-BCMCS Release Complete-A8 message includes a Message Type field, a Correlation ID field, a Cause field, a Mobile Identity field, a Session Information Record field, and a HRPD (High-Rate Packet Data) indicators field.

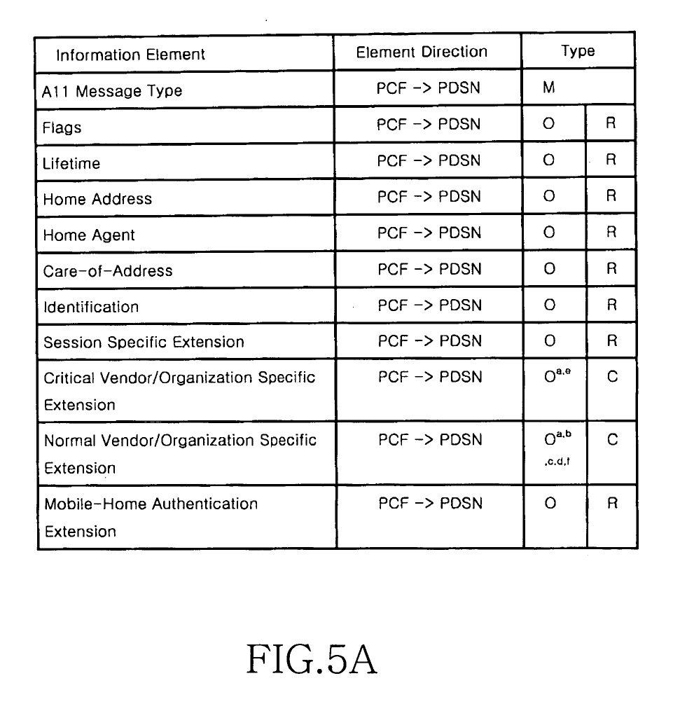

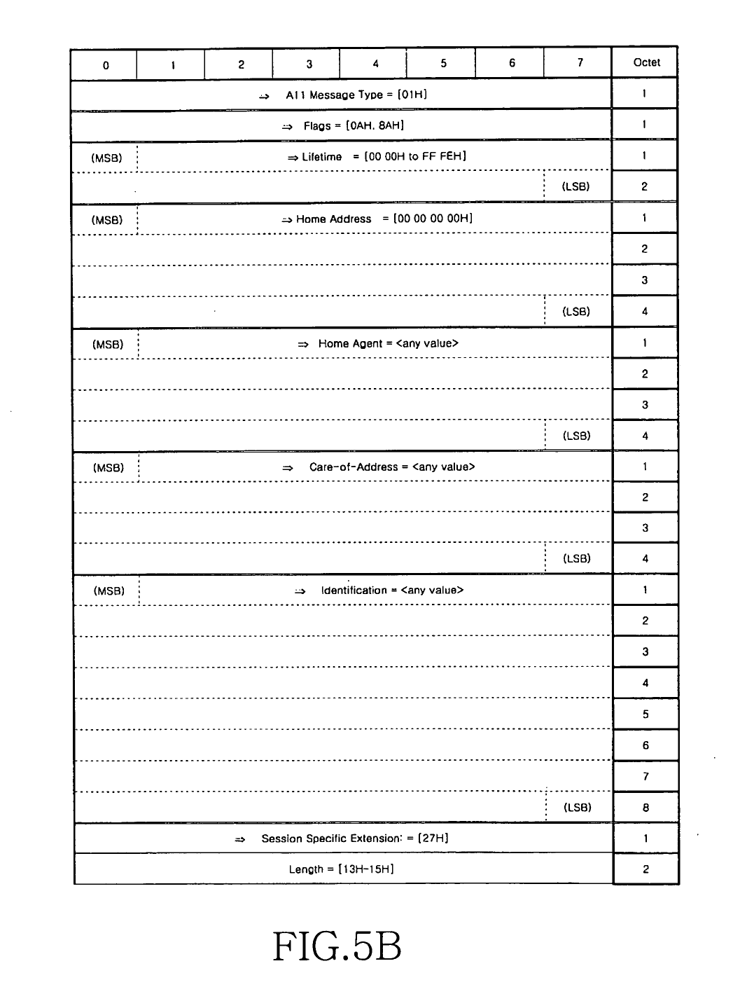

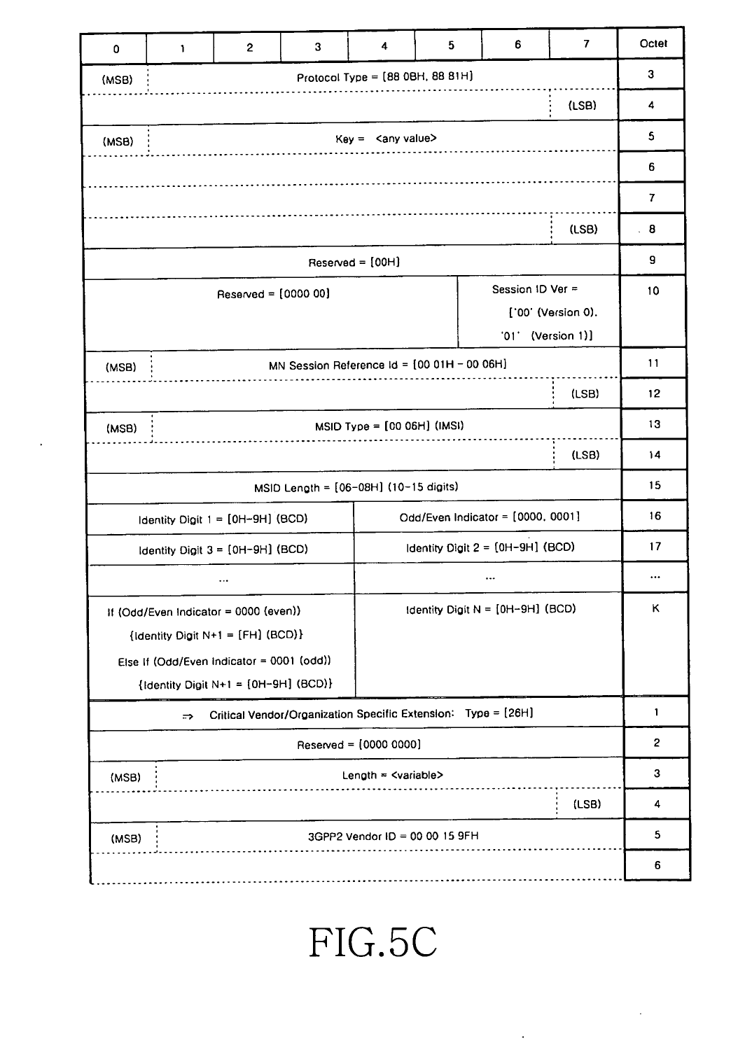

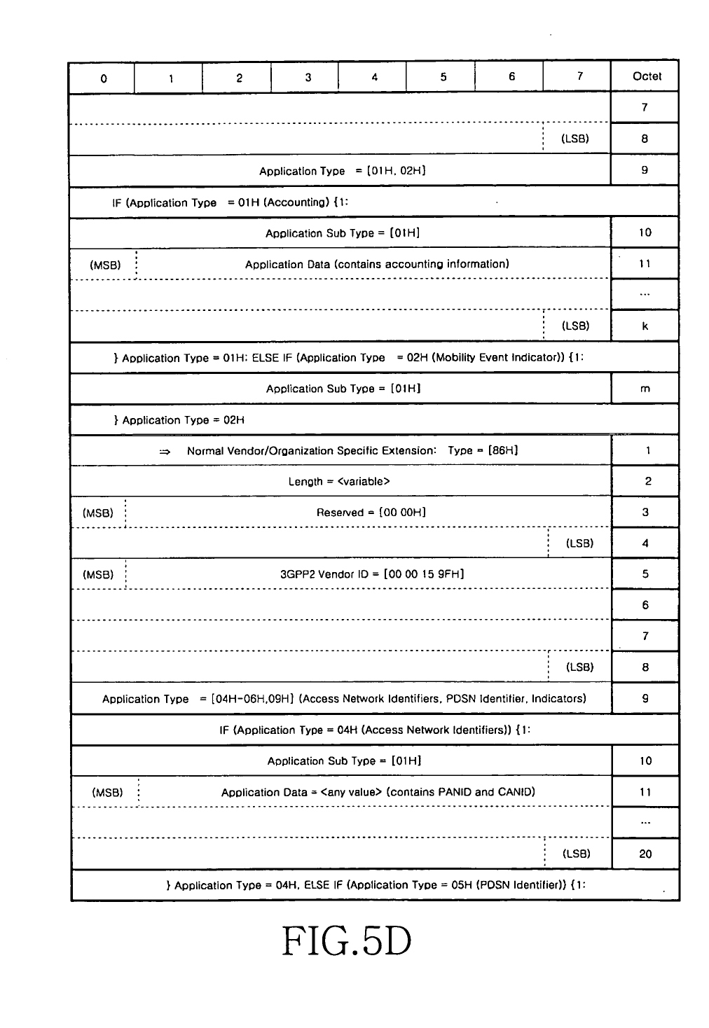

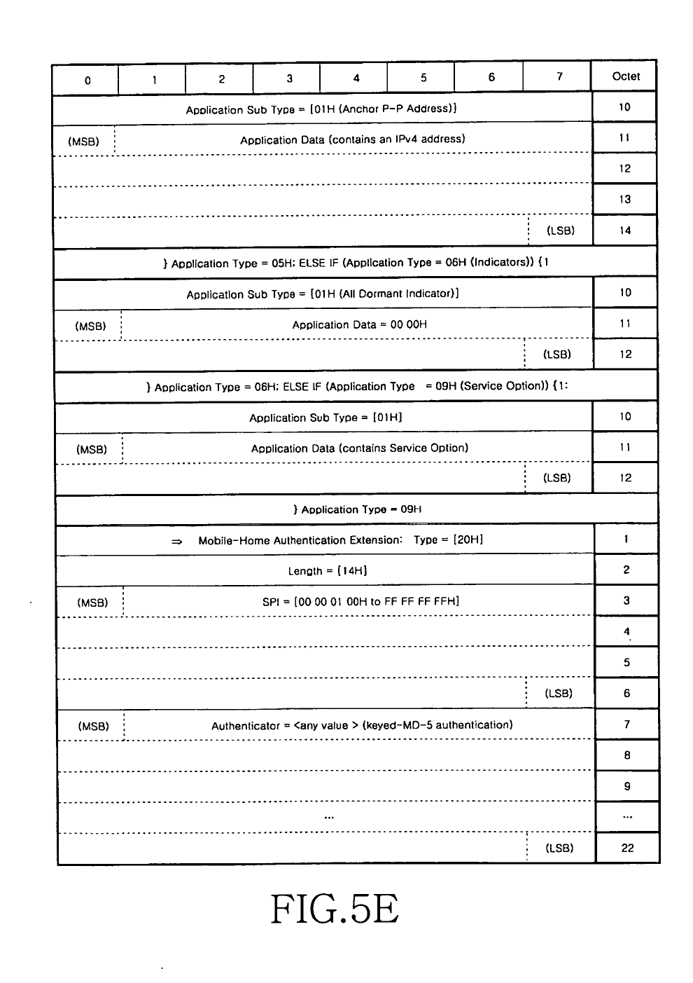

FIG. 5A is a diagram illustrating a simplified format of the A11-BCMCS Registration Request message transmitted from the packet control function to the packet data service node according to an embodiment of the present invention. FIGS. 5B through 5E are diagrams illustrating a detailed format of the A11-BCMCS Registration Request message. As illustrated in FIG. 5A, the A11-BCMCS Registration Request message includes a Message Type field, a Flags field, a Lifetime field, a Home Address field, a Home Agent field, a Care-of-address field, a Identification field, a Session Specific Extension field, a Critical Vendor/Organization Specific Extension (CVSE) field, a Normal Vendor/Organization Specific Extension (NVSE) field, and a Mobile-Home Authentication Extension field.

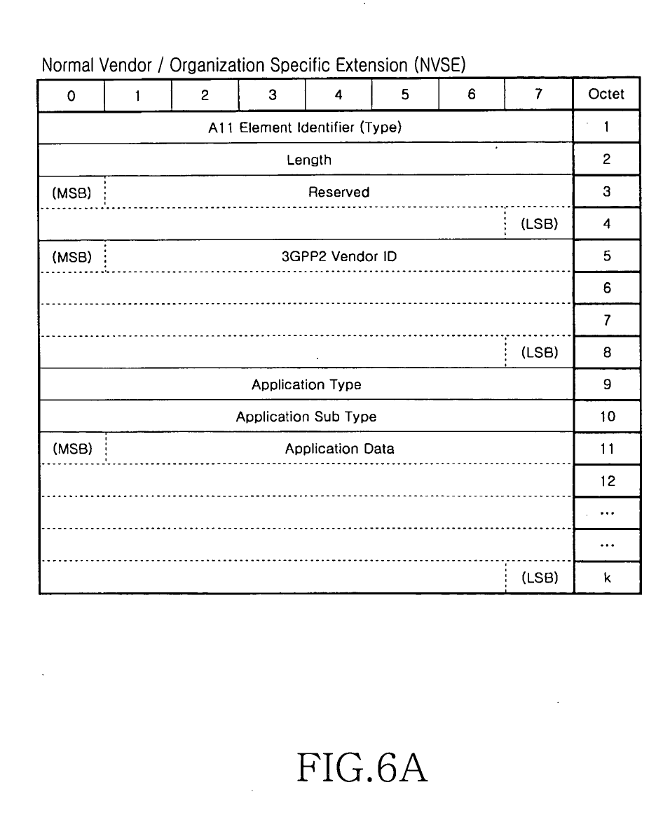

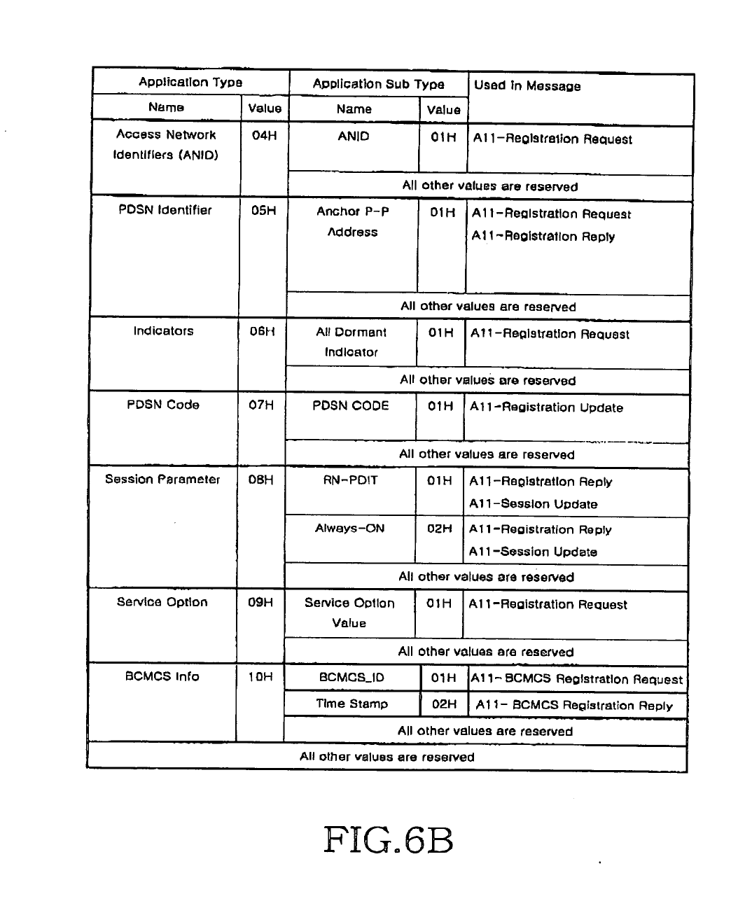

BCMCS Info transmitted from the access network to the packet control function is included in the Normal Vendor/Organization Specific Extension (NVSE) field and then transmitted to the packet data service node. The meaning of the Normal Vendor/Organization Specific Extension field is illustrated in FIGS. 6A and 6B. As illustrated in FIG. 6B, BCMCS Info is written in Application fields in the Normal Vendor/Organization Specific Extension field. When BCMCS Info is written in the Application fields, an Application Type field is set to ‘10H’, and an Application Sub Type field includes BCMCS_ID with a BCMCS release request and Time Stamp for an accounting process on the corresponding BCMCS service.

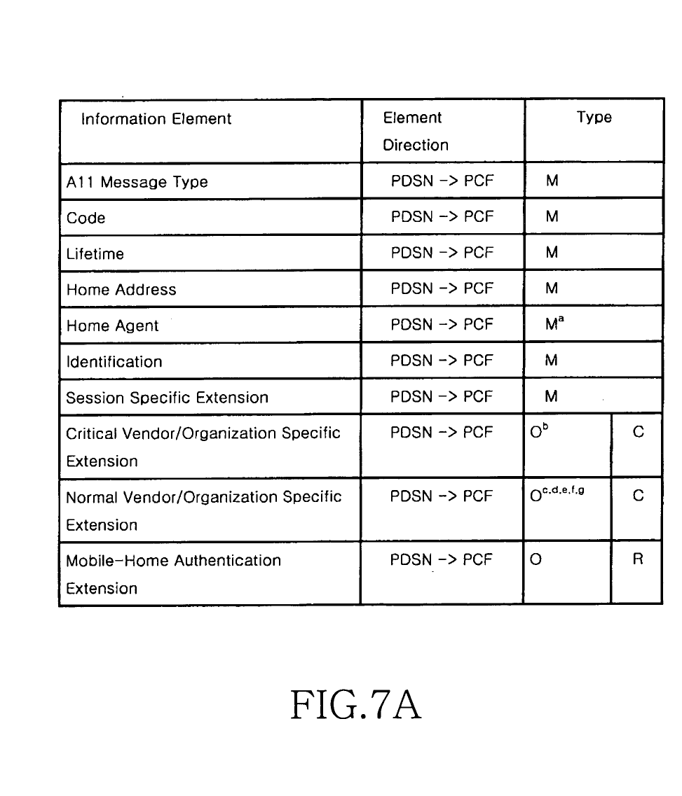

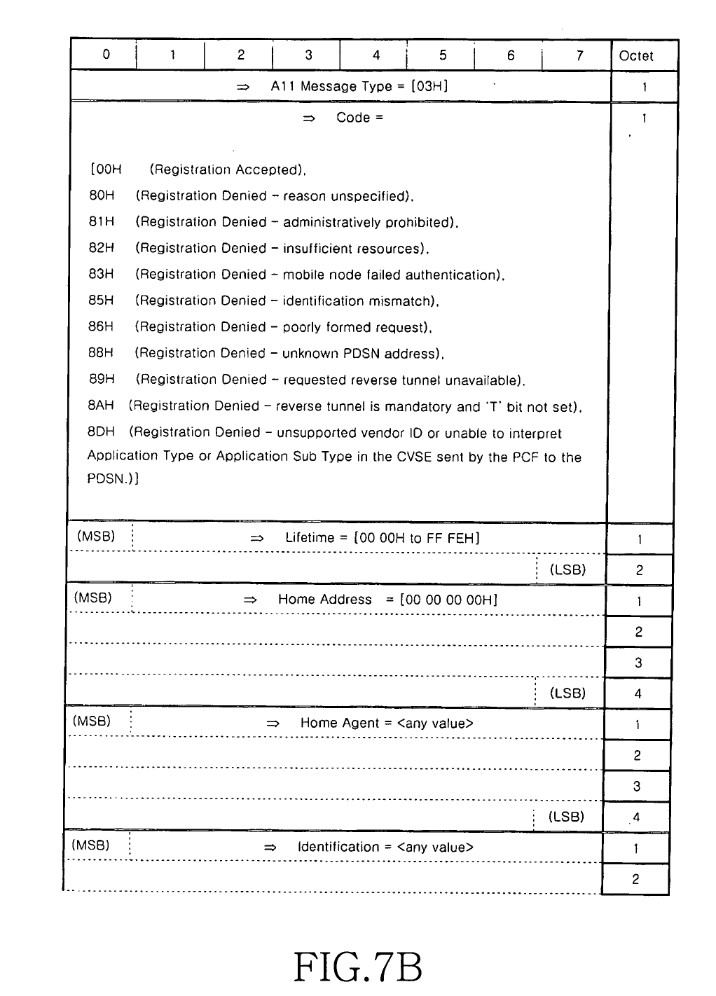

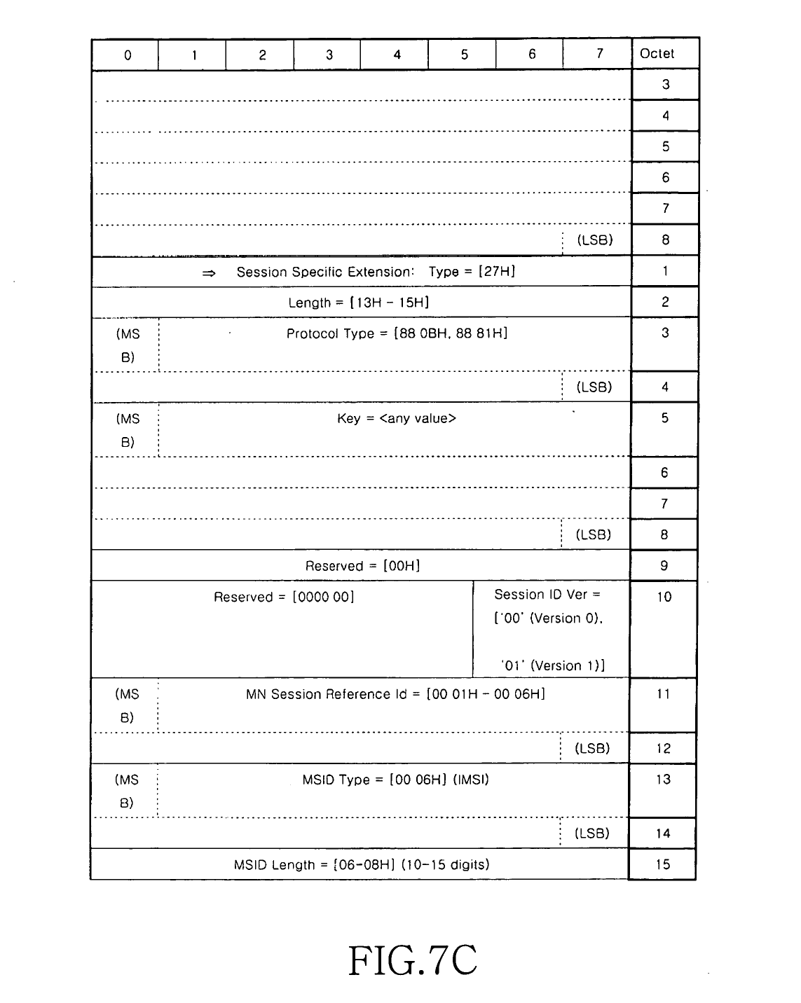

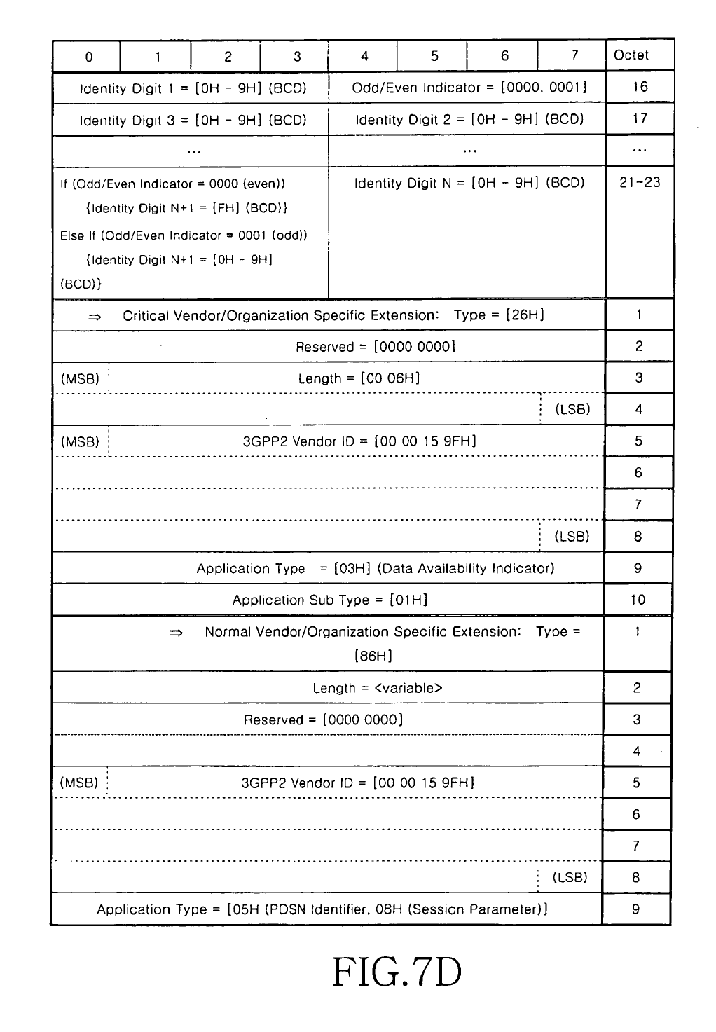

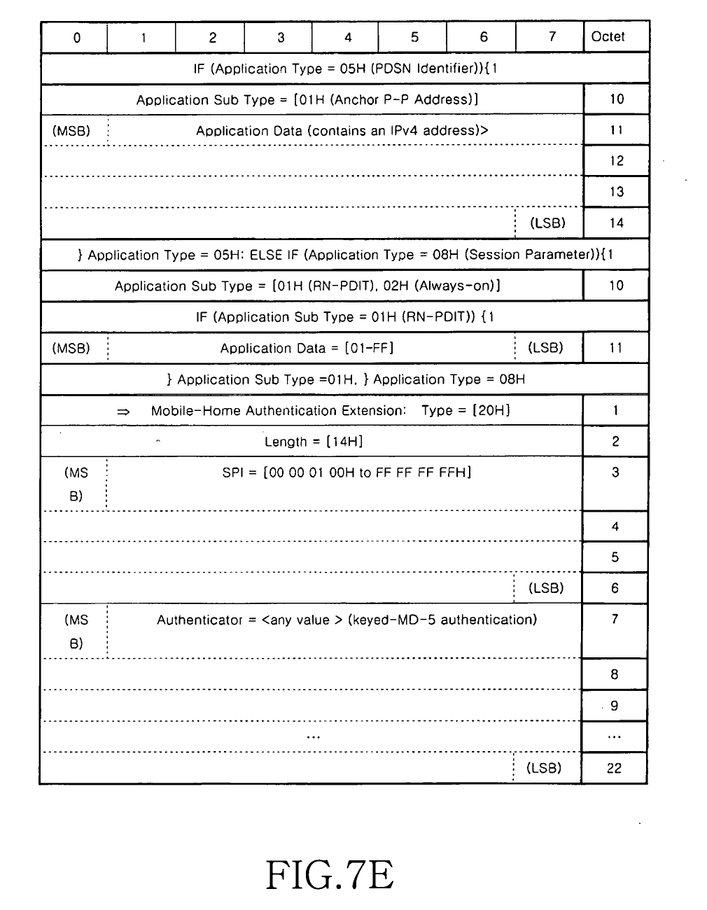

FIG. 7A is a diagram illustrating a simplified format of the A11-BCMCS Registration Reply message transmitted from the packet data service node to the packet control function according to an embodiment of the present invention. FIGS. 7B through 7E are diagrams illustrating a detailed format of the A11-BCMCS Registration Reply message. As illustrated, the A11-BCMCS Registration Reply message includes a Message Type field, a Code field, a Lifetime field, a Home Address field, a Home Agent field, an Identification field, a Session Specific Extension field, a Critical Vendor/Organization Specific Extension (CVSE) field, a Normal Vendor/Organization Specific Extension (NVSE) field, and a Mobile-Home Authentication Extension field.

An embodiment of the present invention has been described so far with reference to a BCMCS de-registration operation performed between the access network (AN), the packet control function (PCF), and the packet data service node (PDSN) when the access terminal (AT) requests suspension of a BCMCS service. Next, another embodiment of the present invention will be described with reference to a BCMCS de-registration operation performed when the packet data service node desires to suspend a specific BCMCS service.

FIG. 8 is a message flow diagram illustrating a BCMCS de-registration method according to another embodiment of the present invention. Referring to FIG. 8, it is assumed that in step ‘a’, an access terminal (AT) is receiving a BCMCS service from a packet data service node (PDSN) via an access network (AN) and a packet control function (PCF). In step ‘b’, the packet data service node sends an A11-BCMCS Registration Update message to the packet control function in order to suspend a corresponding BCMCS service due to a network failure or a failure to receive contents for the corresponding BCMCS from an undepicted contents server. The A11-BCMCS Registration Update message includes BCMCS Info in addition to the basic fields of the A11-BCMCS Registration Request message.

In step ‘c’, the packet control function sends an A11-BCMCS Registration Acknowledge message to the packet data service node in response to the A11-BCMCS Registration Update message. Thereafter, in step ‘d’, the packet control function sends an A9-BCMCS Disconnect-A8 message including BCMCS Info received from the packet data service node to the access network.

In step ‘e’, the access network sends an A9-BCMCS Release-A8 message to the packet control function in response to the A9-BCMCS Disconnect-A8 message in order to release a connection to the access terminal for the corresponding BCMCS service. Likewise, the A9-BCMCS Disconnect-A8 message includes BCMCS Info for a BCMCS service to be released in addition to the fundamental Security Layer Packet and System Time. The BCMCS Info includes BCMCS_ID of the BCMCS service to be released and Time Stamp for an accounting process. When there is no other access terminal receiving the BCMCS service to be released between the access network and the packet control function, the A9-BCMCS Release-A8 message further includes an A8-BCS Traffic ID for the BCMCS service.

In step ‘f’, the packet control function receiving the A9-BCMCS Release-A8 message includes BCMCS Info received from the access network in an A11-BCMCS Registration Request message and sends the A11-BCMCS Registration Request to the packet data service node. The BCMCS Info is recognized as accounting information for a BCMCS service in the packet data service node. If the access terminal is the last user using a corresponding BCMCS connection in the packet control function, i.e., if no more users are receiving the corresponding BCMCS service, a Lifetime field in the A11-BCMCS Registration Request message is set to ‘0’.

In step ‘g’, the packet data service node processes BCMCS accounting for the access terminal, and in response, sends an A11-BCMCS Registration Reply message to the packet control function. In step ‘h’, the packet control function sends an A9-BCMCS Release Complete-A8 message to the access network, thereby indicating completion of the BCMCS de-registration procedure.

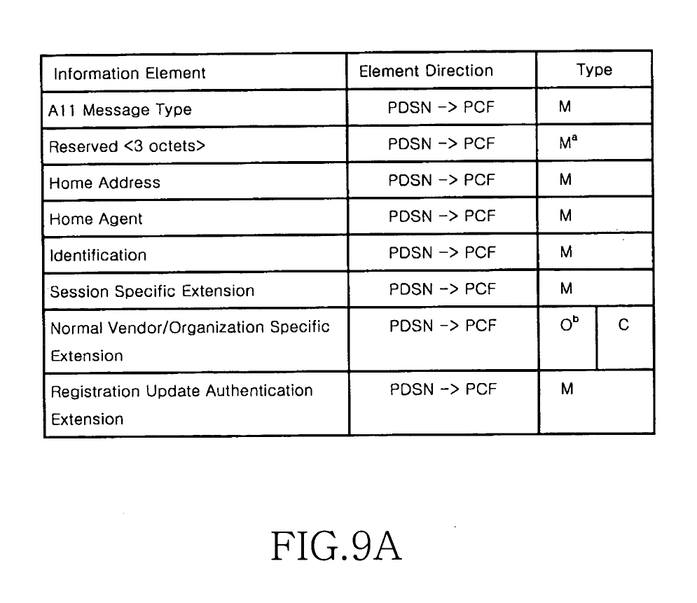

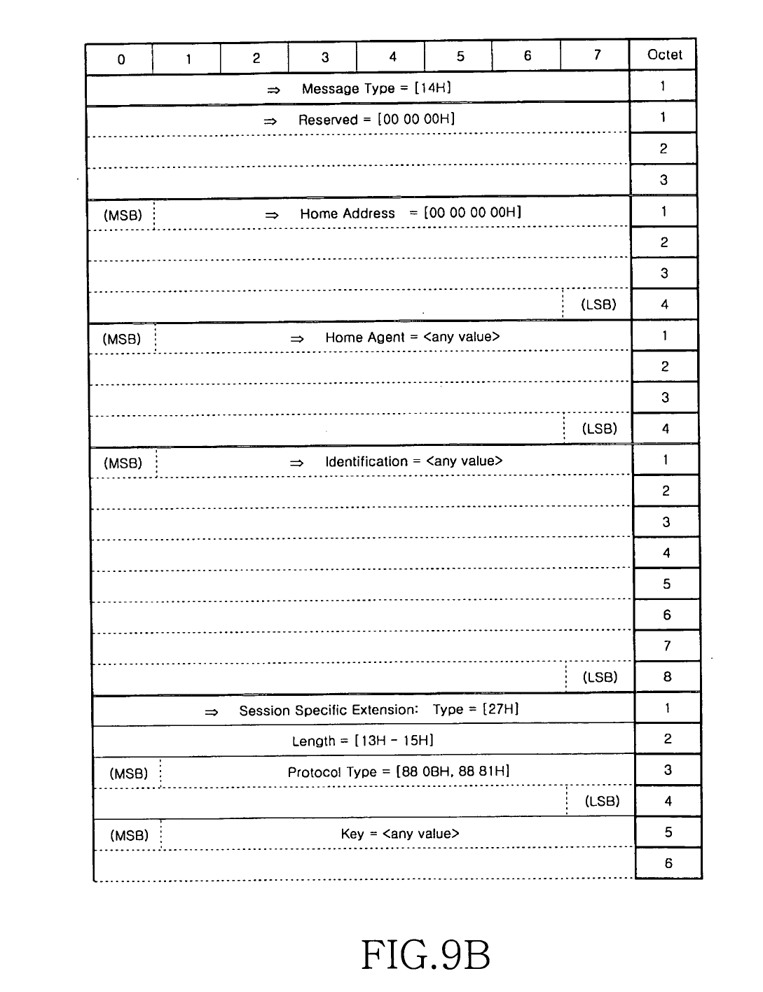

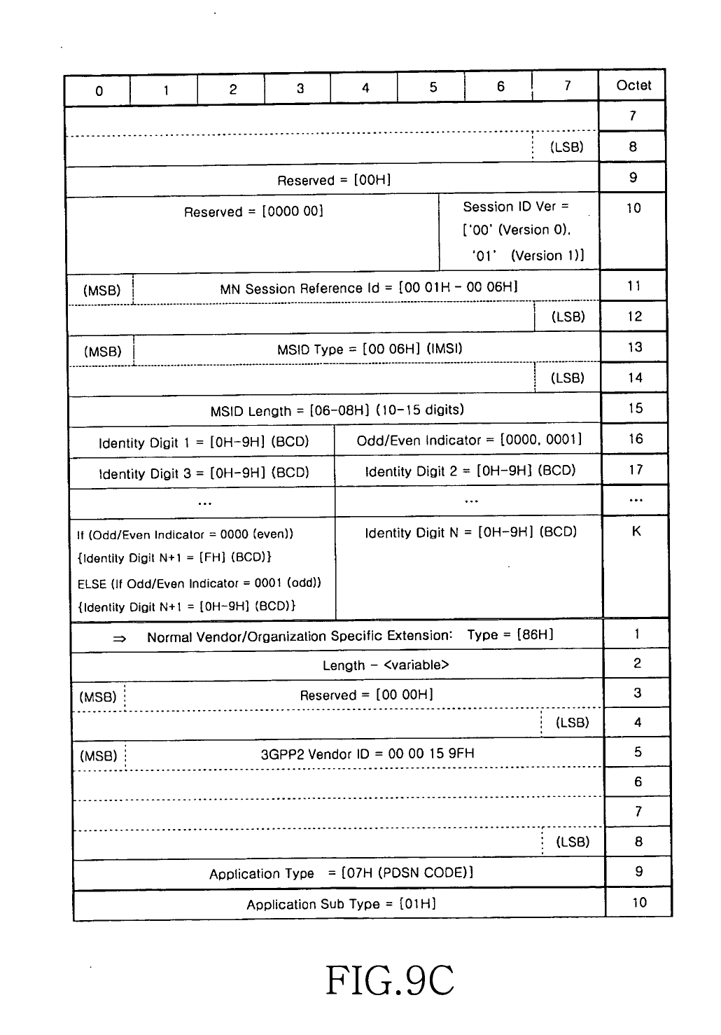

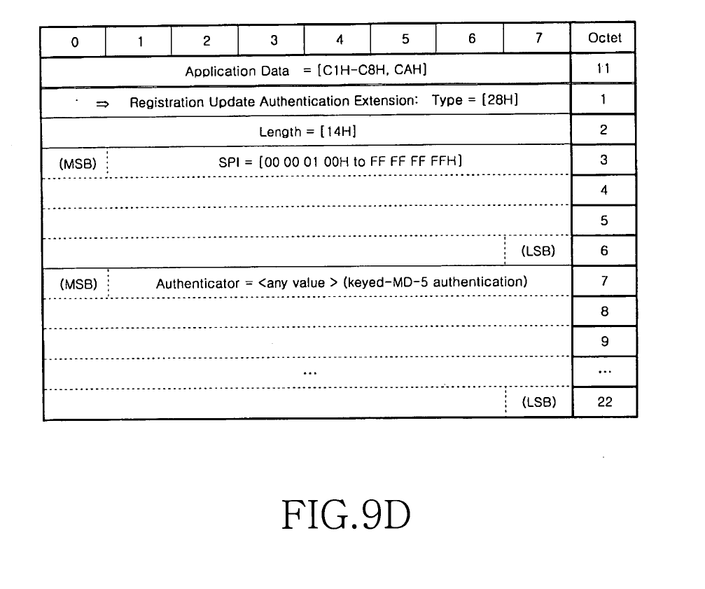

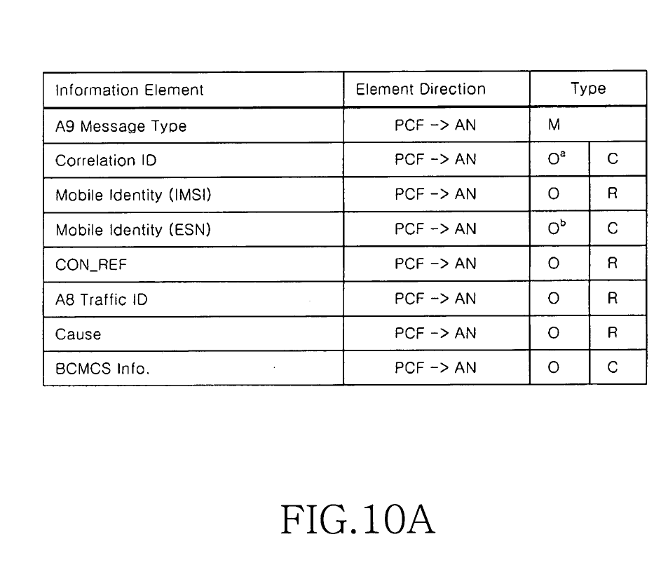

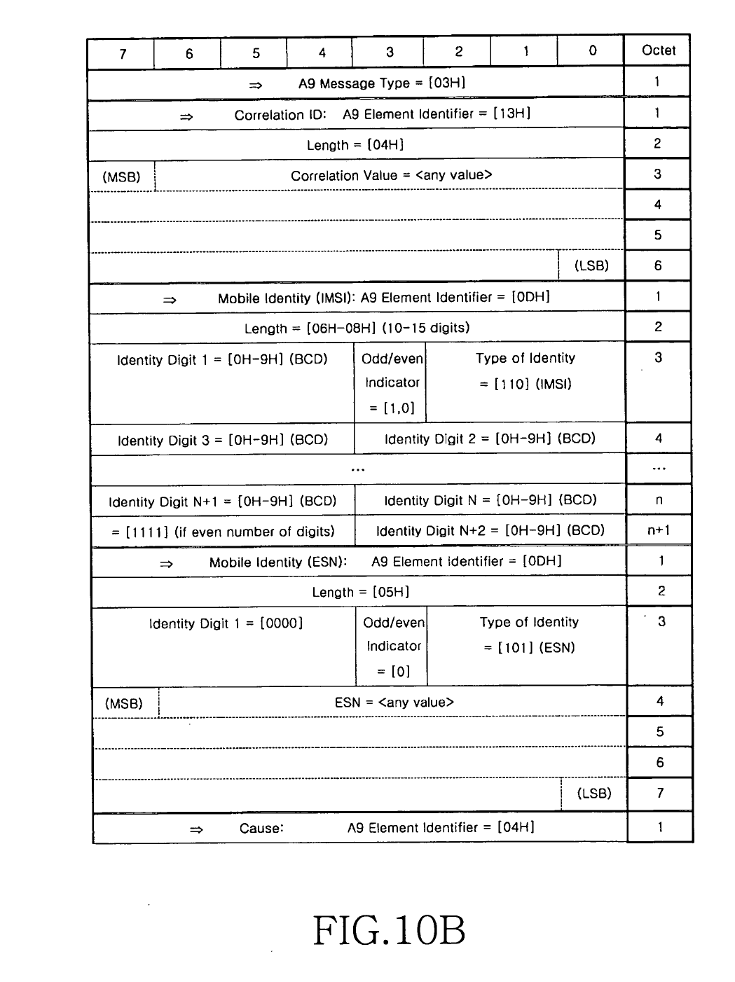

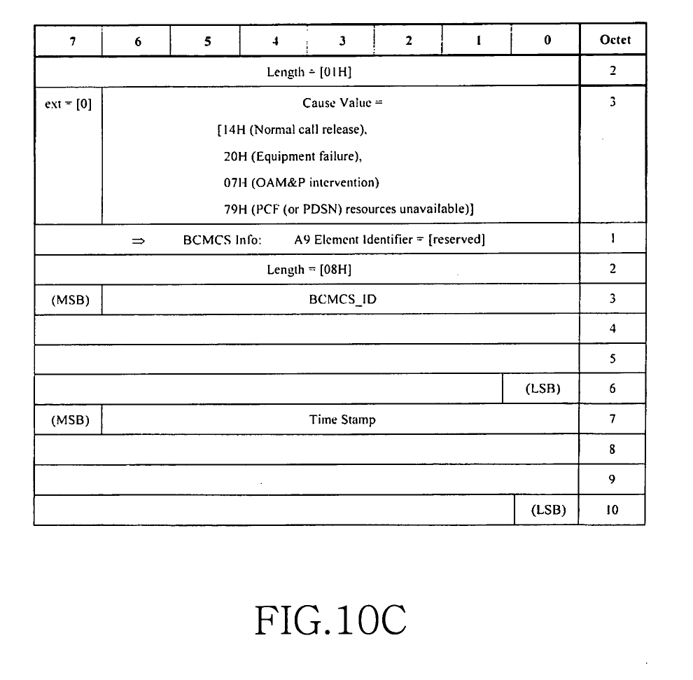

FIGS. 9A through 10C are diagrams illustrating formats of messages transmitted in the BCMCS de-registration method according to another embodiment of the present invention. Among information elements constituting the messages, only the parameters used for BCMCS de-registration will be described in detail, for conciseness.

FIG. 9A is a diagram illustrating a simplified format of the A11-BCMCS Registration Update message transmitted from the packet data service node to the packet control function according to another embodiment of the present invention. FIGS. 9B through 9D are diagrams illustrating a detailed format of the A11-BCMCS Registration Update message.

As illustrated in FIG. 9A, the A11-BCMCS Registration Update message includes a Home Address field, a Home Agent field, an Identification field, a Session Specific Extension field, a Normal Vendor/Organization Specific Extension (NVSE) field, and a Registration Update Authentication Extension field. BCMCS Info provided from the access network is included in the Normal Vendor/Organization Specific Extension (NVSE) field and then transferred to the packet data service node. The meaning of the Normal Vendor/Organization

Specific Extension Field is Illustrated in FIG. 6B.

That is, BCMCS Info is written in Application fields in the Normal Vendor/Organization Specific Extension field. When BCMCS Info is written in the Application fields, an Application Type field is set to ‘10H’, and an Application Sub Type field includes BCMCS_ID with a BCMCS release request and Time Stamp for an accounting process on the corresponding BCMCS service.

FIG. 10A is a diagram illustrating a simplified format of the A9-BCMCS Disconnect-A8 message transmitted from the packet control function to the access network according to another embodiment of the present invention. FIGS. 10B and 10C are diagrams illustrating a detailed format of the A9-BCMCS Disconnect-A8 message.

As illustrated, the A9-BCMCS Disconnect-A8 message includes Message Type field, a Correlation ID field, Mobility Identity fields (IMSI, ESN), a Traffic ID field, a Cause field, and a BCMCS Info field. As illustrated in FIG. 10C, BCMCS Info includes BCMCS_ID and Time Stamp. The BCMCS_ID refers to broadcasting contents the access terminal desires to release, and is received from the packet data service node through the A11-BCMCS Registration Update message. The Time Stamp refers to a time when the A11-BCMCS Registration Update message from the packet data service node is received at the packet control function. The Time Stamp is used for accounting.

As should be understood from the foregoing description, if a user receiving a BCMCS service from a high-rate packet data system requests de-registration of the BCMCS service, a BCMCS release request is transmitted to a higher hierarchy system along with corresponding BCMCS Info so that a BCMCS service is de-registered and accounting can be performed based on a BCMCS registration time and a BCMCS de-registration time, thereby preventing a waste of wire/wireless BCMCS resource.

In addition, when it is difficult to provide a BCMCS service to a user due to a failure to receive the BCMCS service or a network failure, a BCMCS close message is transmitted from a higher hierachy system such as a packet data service node to a lower hierarchy system such as an access network so that BCMCS release and BCMCS accounting can be performed, thereby preventing a waste of wire/wireless BCMCS resource.

While the invention has been shown and described with reference to a certain embodiments thereof, it should be understood by those skilled in the art that various changes in form and details may be made therein without departing from the spirit and scope of the invention as defined by the appended claims.

1. A method for performing Broadcast/Multicast Service (BCMCS) de-registration in an access network (AN) in a high-rate packet data system comprising the access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
receiving a de-registration message for a release request of a BCMCS service from the access terminal;
transmitting a BCMCS release message including BCMCS information for a BCMCS release process by the packet data service node, to the packet control function; and
receiving a BCMCS release complete message from the packet control function in response to the BCMCS release message.

2. The BCMCS de-registration method of claim 1, wherein the BCMCS information includes BCMCS identification (BCMCS ID) for identifying the release-requested BCMCS service.

3. The BCMCS de-registration method of claim 2, wherein the BCMCS information further includes time stamp representative of a time when the access network received the de-registration message

4. The BCMCS de-registration method of claim 1, wherein the step of transmitting a BCMCS release message further comprises:
broadcasting service traffic identification (BCS Traffic ID) indicative of a corresponding BCMCS connection in the BCMCS release message when the de-registration requesting access terminal is a last access terminal using the corresponding BCMCS connection, and disconnecting a connection to the packet control function upon receiving the BCMCS release complete message.

5. The BCMCS de-registration method of claim 1, wherein the BCMCS release message includes a security layer packet field used for security communication with the access terminal and a system time field representative of a lifetime of the security layer packet.

6. A method for performing Broadcast/Multicast Service (BCMCS) de-registration in a packet control function in a high-rate packet data system comprising an access network (AN) for performing radio communication with an access terminal (AT), the packet control function (PCF) for processing packet data communication, and a packet data service node (PDSN) connected to a BCMCS contents server (CS) via a packet communication network, the method comprising the steps of:
receiving a BCMCS release message for a release request of a BCMCS service from the access network;
transmitting a BCMCS registration request message including BCMCS information for a BCMCS release process to the packet data service node; and
receiving a BCMCS registration reply message from the packet data service node according to a result of the release process, and sending a BCMCS release complete message to the access network.

7. The BCMCS de-registration method of claim 6, wherein the step of transmitting a BCMCS registration request message further comprises:
setting a lifetime field of the BCMCS registration request message to ‘0’ when the de-registration requesting access terminal is a last access terminal receiving the corresponding BCMCS service.

8. The BCMCS de-registration method of claim 6, wherein the BCMCS information comprises BCMCS identification (BCMCS ID) for identifying the release-requested BCMCS service

9. The BCMCS de-registration method of claim 8, wherein the BCMCS information further includes time stamp representative of a time when the access network received the de-registration message.

10. The BCMCS de-registration method of claim 8, wherein the BCMCS information is included in application files in a normal vendor/organization specific extension (NVSE) field comprising the BCMCS registration request message.

11. A method for de-registering Broadcast/Multicast Service (BCMCS) in a high-rate packet data system comprising an access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
receiving by the access network a de-registration message for a release request of a BCMCS service from the access terminal;
transmitting by the access network a BCMCS release message including BCMCS information with a release request, to the packet control function;
transmitting by the packet control function a BCMCS registration request message including the BCMCS information to the packet data service node;
performing by the packet data service node a release process on a corresponding BCMCS service based on the BCMCS information;
transmitting by the packet data service node a BCMCS registration reply message to the packet control function in response to the BCMCS registration request message; and
transmitting by the packet control function a BCMCS release complete message indicating completion of a release process on the corresponding BCMCS service to the access network.

12. The method of claim 11, further comprising the step of performing by the packet data service node an accounting process on the released BCMCS service based on BCMCS information.

13. The method of claim 11, wherein the step of transmitting a BCMCS release message further comprises:
broadcasting service traffic identification (BCS Traffic ID) indicative of a corresponding BCMCS connection in the BCMCS release message when the de-registration requesting access terminal is a last access terminal using the corresponding BCMCS connection, and disconnecting a connection to the packet control function upon receiving a BCMCS release complete message.

14. The method of claim 11, wherein the step of transmitting a BCMCS registration request message further comprises:
setting a lifetime field of the BCMCS registration request message to ‘0’ when the de-registration requesting access terminal is a last access terminal receiving the corresponding BCMCS service.

15. A method for performing Broadcast/Multicast Service (BCMCS) de-registration in a packet control function in a high-rate packet data system comprising an access network (AN) for performing radio communication with an access terminal (AT), the packet control function (PCF) for processing packet data communication, and a packet data service node (PDSN) connected to a BCMCS contents server (CS) via a packet communication network, the method comprising the steps of:
receiving a BCMCS registration update message including BCMCS information for a BCMCS service to be released, from the packet data service node;
transmitting BCMCS disconnect message including the BCMCS information to the access network;
receiving a response message from the access network in response to the BCMCS disconnect message;
transmitting a BCMCS registration request message for a BCMCS release process to the packet data service node;
receiving a BCMCS registration reply message from the packet data service node according to a result of the release process and
transmitting a BCMCS release complete message indicating completion of the BCMCS release process to the access network.

16. The BCMCS de-registration method of claim 15, wherein the step of transmitting a BCMCS registration request message further comprises:
setting a lifetime field of the BCMCS registration request message to ‘0’ when the access terminal receiving the BCMCS service on which the release process is performed is a last access terminal.

17. The BCMCS de-registration method of claim 15, wherein the BCMCS information includes BCMCS identification (BCMCS ID) for identifying the BCMCS service to be released.

18. The BCMCS de-registration method of claim 17, wherein the BCMCS information further includes time stamp indicating a release time of the BCMCS service.

19. The BCMCS de-registration method of claim 15, wherein the BCMCS information is included in application files in a normal vendor/organization specific extension (NVSE) field comprising the BCMCS registration request message.

20. A Broadcast/Multicast Service (BCMCS) de-registration method performed in an access network in a high-rate packet data system comprising the access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
receiving a BCMCS disconnect message including BCMCS information for a BCMCS service to be released, from the packet control function;
transmitting a BCMCS release message including the BCMCS information to the packet control function in order to release a connection to the access terminal; and
receiving a BCMCS release complete message from the packet control function according to a result of a BCMCS release process by the packet data service node.

21. The BCMCS de-registration method of claim 20, wherein the BCMCS information includes BCMCS identification (BCMCS ID) for identifying the BCMCS service to be released.

22. The BCMCS de-registration method of claim 21, wherein the BCMCS information further includes time stamp indicating a release time of the BCMCS service.

23. The BCMCS de-registration method of claim 20, wherein the step of transmitting a BCMCS release message further comprises:
including broadcast service traffic identification (BCS Traffic ID) indicative of a corresponding BCMCS connection in the BCMCS release message when the access terminal using the BCMCS service to be released is a last access terminal using the corresponding BCMCS connection, and disconnecting a connection to the packet control function upon receiving the BCMCS release complete message.

24. The BCMCS de-registration method of claim 20, wherein the BCMCS release message includes a security layer packet field used for security communication with the access terminal and a system time field representative of a lifetime of the security layer packet.

25. A method for de-registering Broadcast/Multicast Service (BCMCS) in a high-rate packet data system comprising an access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
transmitting by the packet data service node a BCMCS registration update message including BCMCS information for a BCMCS service to be released, to the packet control function;
transmitting by the packet control function a BCMCS disconnect message including the BCMCS information to the access network;
transmitting by the access network a BCMCS release message including the BCMCS information to the packet control function in order to disconnect a connection to the access terminal;
transmitting by the packet control function a BCMCS registration request message including the BCMCS information to the packet data service node;
performing by the packet data service node a release process on a corresponding BCMCS service based on the BCMCS information; and
receiving by the packet control function a BCMCS registration reply message indicating release of the corresponding BCMCS service from the packet data service node, and sending a BCMCS release complete message to the access network.

26. The method of claim 25, further comprising the step of performing by the packet data service node an accounting process on the released BCMCS service based on the BCMCS information.

27. The method of claim 25, wherein the BCMCS information includes BCMCS identification (BCMCS ID) for identifying the BCMCS service to be released.

28. The method of claim 25, wherein the step of transmitting a BCMCS release message further comprises:
including broadcast service traffic identification (BCS Traffic ID) indicative of a corresponding BCMCS connection in the BCMCS release message when the access terminal using the BCMCS service to be release is a last access terminal using the corresponding BCMCS connection, and disconnecting a connection to the packet control function upon receiving a BCMCS release complete message.

29. The method of claim 25, wherein the step of transmitting a BCMCS registration request message further comprises:
setting a lifetime field of the BCMCS registration request message to ‘0’ when the access terminal receiving the BCMCS service on which the release process is performed is a last access terminal.

30. A broadcasting service system for de-registering Broadcast/Multicast Service (BCMCS) in response to a request from an access terminal in a high-rate packet data system, comprising:
an access network for performing a radio communication with the access terminal, and transmitting a BCMCS release message including BCMCS information with a release request to a packet control function upon receiving a de-registration message for release request of a BCMCS service from the access terminal; and
a packet data service node for performing a release process on a corresponding BCMCS service based on the BCMCS information upon receiving a BCMCS registration request message including the BCMCS information from the packet control function receiving the BCMCS release message.

31. The broadcasting service system of claim 30, wherein the BCMCS information includes BCMCS identification (BCMCS ID) for identifying the BCMCS service to be released.

32. The broadcasting service system of claim 31, wherein the BCMCS information further includes time stamp indicating a release time of the BCMCS service.

33. The broadcasting service system of claim 32, wherein the packet data service node further performs an accounting process on a corresponding access terminal based on the time stamp.

34. A broadcasting service system for de-registering Broadcast/Multicast Service (BCMCS) in response to a request from a packet data service node connected to a BCMCS contents server via a packet communication network, comprising:
the packet data service node for, upon failure to receive broadcasting contents, transmitting a BCMCS registration update message including BCMCS information to a packet control function to request release of a BCMCS service, and performing a release process on the corresponding BCMCS service upon receiving an acknowledge message including the BCMCS information from the packet control function; and
an access network connected to an access terminal, for transmitting a BCMCS release message including BCMCS information to the packet control function to disconnect a connection to the access terminal when a BCMCS disconnect message including the BCMCS information is received from the packet control function in response to the release request.

35. The broadcasting service system of claim 34, wherein the BCMCS information includes BCMCS identification (BCMCS ID) for identifying the BCMCS service to be released.

36. The broadcasting service system of claim 34, wherein the BCMCS information further includes time stamp indicating a release time of the BCMCS service.

37. The broadcasting service system of claim 36, wherein the packet data service node further performs an accounting process on a corresponding access terminal based on the time stamp.
